(19) United States
(12) Patent Application Publication
(10) Pub. No.: US 2026/0149484 A1
(43) Pub. Date: May 28, 2026

(54) IN-VEHICLE NETWORK SYSTEM AND CONTROL METHOD FOR IN-VEHICLE NETWORK SYSTEM

(71) Applicant: DENSO CORPORATION, Kariya-city (JP)

(72) Inventors: Sho MATSUMOTO, Kariya-city (JP); Tomohisa KISHIGAMI, Kariya-city (JP); Youichi HAYASE, Kariya-city (JP)

(21) Appl. No.: 19/359,240

(22) Filed: Oct. 15, 2025

(30) Foreign Application Priority Data
Nov. 22, 2024 (JP) 2024-204142

(51) Int. Cl. H04B 3/58; H04L 12/40

(52) U.S. Cl. CPC H04B 3/58; H04L 12/40; H04L 2012/40273

(57) ABSTRACT

An in-vehicle network system is controlled by transmitting, to a second controller, a relay control message containing an instruction to turn on or off a relay circuit based, which is disposed on a power supply line to a first controller, on a vehicle state of a vehicle, transmitting, to the second controller, an activation network management message, which causes the second controller to transition from a low-power consumption mode to the normal operation mode and contains an instruction to selectively activate the first controller, in response to an activation trigger, and turning on or off the relay circuit based on the instruction contained in the activation NM message until the second controller receives the relay control message.

### CROSS REFERENCE TO RELATED APPLICATION

The present application claims the benefit of priority from Japanese Patent Application No. 2024-204142 filed on Nov. 11, 2024. The entire disclosure of the above application is incorporated herein by reference.

### TECHNICAL FIELD

The present disclosure relates to an in-vehicle network system having multiple control devices that are connected to a communication bus and capable of mutually communicating with each other in a vehicle, and to a control method for the in-vehicle network system.

### BACKGROUND ART

There is an in-vehicle device capable of interrupting power supply from a power supply device to an in-vehicle ECU that does not require activation, thereby avoiding activation of in-vehicle ECUs for which activation is unnecessary.

### SUMMARY

An in-vehicle network system of the present disclosure includes a first control device including at least one of (i) a first circuit and (ii) a first processor with a memory storing computer program code executable by the first processor, and a second control device including at least one of (i) a second circuit and (ii) a second processor with a memory storing computer program code executable by the second processor. The second control device is hierarchically higher than the first control device. The first control device and the second control device are connected to a communication bus to communicate with each other in a vehicle. The first control device is configured to perform predetermined processing with electric power supplied through a relay circuit disposed on a power supply line to the first control device, and may regularly transmit periodical messages during the predetermined processing. The second control device is configured to turn on or off the relay circuit based on vehicle state information regarding a state of the vehicle. The second control device may be configured to keep the relay circuit on while the first control device transmits the periodical messages, even when the vehicle state information changes to have information based on which the relay circuit is turned off.

### BRIEF DESCRIPTION OF DRAWINGS

FIG. 1 is a configuration diagram showing an example of the configuration of an in-vehicle network system according to the first embodiment.

FIG. 2 is a sequence diagram illustrating a case where the first and second intermediate ECUs turn off first to third relay circuits based solely on vehicle state information.

FIG. 3 is a sequence diagram illustrating a case where the first and second intermediate ECUs turn off the first to third relay circuits based not only on the vehicle state information, but also on periodic messages periodically transmitted from the first to third lower-level ECUs.

FIG. 4 is a flowchart showing an example of processing executed in the higher-level ECU, the first and second intermediate ECUs, and the first to third lower-level ECUs to turn the first to third relay circuits on or off.

FIG. 5 is a configuration diagram showing an example of the configuration of an in-vehicle network system according to the second embodiment.

FIG. 6 is a sequence diagram illustrating a case in the second embodiment where the first and second intermediate ECUs turn off the first relay circuit based on the vehicle state information and periodic messages periodically transmitted from the first and second lower-level ECUs.

FIG. 7 is a configuration diagram showing an example of the configuration of an in-vehicle network system according to the third embodiment.

### DESCRIPTION OF EMBODIMENTS

To begin with, examples of relevant techniques will be described.

For example, there is an in-vehicle device capable of interrupting power supply from a power supply device to an in-vehicle ECU that does not require activation. The in-vehicle device is connected to multiple in-vehicle ECUs to be able to communicate with the in-vehicle ECUs. The in-vehicle device acquires information regarding an in-vehicle ECU to be activated via an in-vehicle network. Then, the in-vehicle device supplies power to the in-vehicle ECU to be activated, and outputs an activation signal via the in-vehicle network while cutting off power supply to in-vehicle ECUs for which activation is unnecessary. As a result, only the in-vehicle ECU to be activated is started by the activation signal, and activation of in-vehicle ECUs for which activation is unnecessary is avoided.

The system described above does not address stopping the power supply to the in-vehicle ECU which has been activated. For example, when the in-vehicle device activates at least one of in-vehicle ECUs based on information regarding the in-vehicle ECUs to be activated that was obtained in the past, but the relevant in-vehicle ECU was no longer included as a target for activation in information regarding the in-vehicle ECU to be activated that was subsequently obtained, the in-vehicle device will shut off the power supply to the relevant in-vehicle ECU based on the subsequently obtained information regarding the in-vehicle ECU to be activated.

However, if the power supply to the relevant in-vehicle ECU is shut off without taking into consideration the circumstances of that ECU, there is a risk that various problems may occur. For example, if the power supply to the relevant in-vehicle ECU is cut off while it is still in the process of performing operations necessary to fulfill a specific function, that specific function will be interrupted. In addition, if the processing required to fulfill a specific function has been completed and the in-vehicle ECU is executing shutdown processing such as backing up data including processing history or learning results, cutting off the power supply to the in-vehicle ECU at that time may result in the necessary data not being saved.

The present disclosure has been made in view of the above points, and provides an in-vehicle network system and a control method for the in-vehicle network system that are capable of interrupting the power supply to a lower-level control device, which receives power via a relay circuit, at an appropriate timing.

To achieve the above objects, an in-vehicle network system according to the present disclosure includes a first control device and a second control device that is hierarchically higher than the first control device. The first control device and the second control device are connected to a communication bus to communicate with each other in a vehicle. The first control device is configured to perform predetermined processing with electric power supplied through a relay circuit disposed on a power supply line to the first control device, and regularly transmit periodical messages during the predetermined processing. The second control device includes a relay control unit configured to turn on or off the relay circuit based on vehicle state information regarding a state of the vehicle. The relay control unit is configured to keep the relay circuit on while the first control device transmits the periodical messages, even when the vehicle state information changes to have information based on which the relay control unit turns off the relay circuit.

Further, to achieve the above objects, a control method for an in-vehicle network system including a first control device and a second control device includes receiving periodical messages from the first control device with the second control device through a communication bus in a vehicle. The first control device regularly transmits the periodical messages while performing predetermined processing with power supplied through a relay circuit that is disposed on a power supply line. The second control device is hierarchically higher than the first control device and includes a relay control unit configured to switch the relay circuit according to vehicle state information regarding a state of the vehicle. The control method further includes keeping the relay circuit on while receiving the periodical messages from the first control device, even when the vehicle state information changes to have information based on which the relay control unit turns off the relay circuit.

In the in-vehicle network system and the control method according to the present disclosure, the relay control unit of the second control device keeps the relay circuit on as long as periodic messages are being transmitted from the first control device, even when the vehicle state information changes to have information based on which the relay control unit turns off the relay circuit.

Thus, according to the in-vehicle network system and the control method of the present disclosure, it is possible to prevent the supply of power to the first control device from being interrupted while the first control device is performing predetermined processing. In other words, the power supply to the first control device can be cut off at an appropriate timing after the predetermined processing has been completed.

Technical features other than the above-mentioned characteristics of the present disclosure, as described in the respective claims of the claims, will become apparent from the following description of the embodiments and the accompanying drawings.

Hereinafter, embodiments of an in-vehicle network system and a control method for the in-vehicle network system according to the present disclosure will be described with reference to the drawings. However, the present disclosure is not limited to the embodiments described below, and various modifications described later are also included within the technical scope of the present disclosure. Furthermore, various modifications may be made without departing from the spirit of the present disclosure, in addition to those described below. The embodiments and various modified examples can be combined within a scope that does not cause technical inconsistency. In the following description, the same or similar components may be denoted by the same reference symbol throughout the drawings, and descriptions thereof may be omitted. In addition, in a case where only a part of the configuration is referred to in an embodiment or modification example, the description in the foregoing embodiment may be applied to the remaining configuration.

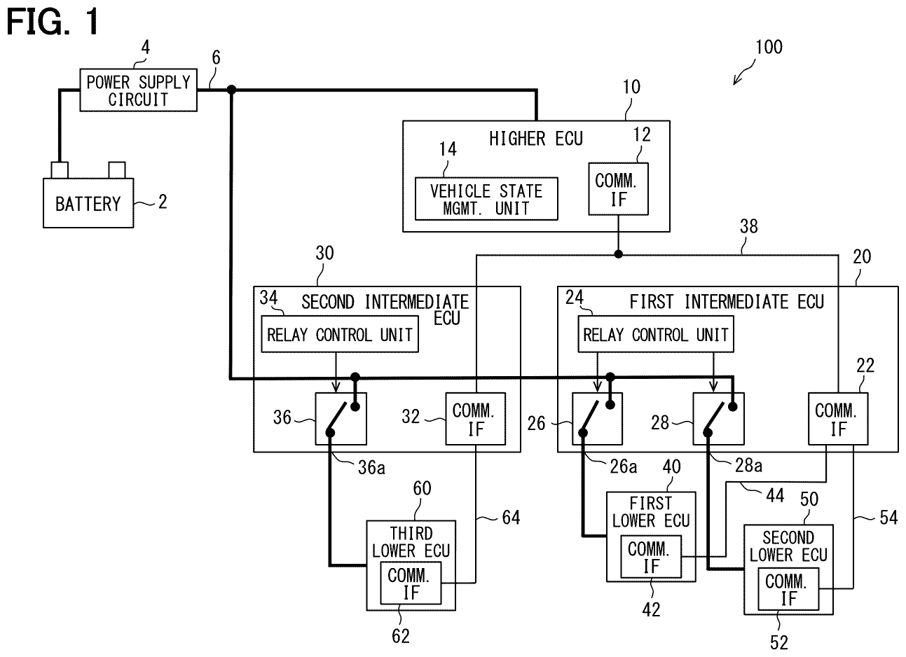

(First Embodiment) FIG. 1 is a configuration diagram illustrating an example of the configuration of an in-vehicle network system 100 according to the present embodiment. The in-vehicle network system 100 shown in FIG. 1 includes a higher-level ECU 10 as a third control device, first and second intermediate ECUs 20 and 30 as second control devices, and first to third lower-level ECUs 40, 50, and 60 as first control devices. ECU is an abbreviation for Electronic Control Unit.

The in-vehicle network system 100 operates by receiving power supplied from a battery 2 installed in the vehicle. More specifically, electric power from the battery 2 is supplied to the higher-level ECU 10, the first and second intermediate ECUs 20 and 30, and the first to third lower-level ECUs 40, 50, and 60 of the in-vehicle network system 100 via a power supply circuit 4. The power supply circuit 4 can convert the supply voltage of the battery 2 installed in the vehicle to the operating voltages of the higher-level ECU 10, the first and second intermediate ECUs 20 and 30, and the first to third lower-level ECUs 40, 50, and 60, as necessary. Power supply lines 6 for the first to third lower-level ECUs 40, 50, and 60 are provided with first to third relay circuits 26, 28, and 36, which can be switched between on and off by the first and second intermediate ECUs 20 and 30.

The configuration of the in-vehicle network system 100 is not limited to the example shown in FIG. 1. For example, the number of higher-level ECUs 10 may be two or more, rather than just one. Additionally, any of the intermediate ECUs 20 or 30 may also serve as the higher-level ECU 10, in which case the higher-level ECU 10 may be omitted. The number of intermediate ECUs 20 and 30 may be one instead of two, or three or more. Regarding the lower-level ECUs 40, 50, and 60, multiple lower-level ECUs may be connected to a single relay circuit 26, 28, or 36. Additionally, one or some of the lower-level ECUs 40, 50, and 60 may be supplied with power directly from the power supply circuit 4, without through the relay circuits 26, 28, or 36.

The higher-level ECU 10, the first and second intermediate ECUs 20 and 30, and the first to third lower-level ECUs 40, 50, and 60 may each be formed of a computer equipped with components such as a processor, memory, and storage. The processor may be a CPU (Central Processing Unit), MPU (Micro Processing Unit), GPU (Graphics Processing Unit), DFP (Data Flow Processor), which execute predetermined processing in accordance with a program. The memory is a volatile storage medium, such as RAM (Random Access Memory), which temporarily stores calculation results and other data from the processor. The storage is a non-volatile storage medium, such as flash memory or ROM (Read Only Memory). Various programs and data to be executed by the processor are stored in the storage.

Furthermore, the storage may store backup data such as processing history and learning results through end processing executed by the first to third lower-level ECUs 40, 50, and 60 upon completion of control processing. The predetermined processing of the present disclosure includes control processing and end processing. The control processing and end processing will be described in detail later. It should be noted that some or all of the functions provided by the higher-level ECU 10, the first and second intermediate ECUs 20 and 30, and the first to third lower-level ECUs 40, 50, and 60 may be implemented not by software such as a program, but by hardware, for example, using an ASIC (Application Specific Integrated Circuit) or an FPGA (Field-Programmable Gate Array).

The higher-level ECU 10, the first and second intermediate ECUs 20 and 30, and the first to third lower-level ECUs 40, 50, and 60 are further provided with communication interfaces (communication IFs) 12, 22, 32, 42, 52, and 62 for communicating with other ECUs via communication buses 38, 44, 54, and 64.

The communication IF 12 of the higher-level ECU 10 is connected to the communication IFs 22 and 32 of the first and second intermediate ECUs 20 and 30 via the communication bus 38. The first and second intermediate ECUs 20 and 30 can also communicate with each other via the communication bus 38. However, the communication bus connecting the higher-level ECU 10 with the first and second intermediate ECUs 20 and 30 may be provided separately from the communication bus connecting the first and second intermediate ECUs 20 and 30 with each other. The communication IF 22 of the first intermediate ECU 20 is further connected to the communication IF 42 of the first lower-level ECU 40 via the communication bus 44. In addition, the communication IF 22 of the first intermediate ECU 20 is connected to the communication IF 52 of the second lower-level ECU 50 via the communication bus 54. The communication IF 42 of the first lower-level ECU 40 and the communication IF 52 of the second lower-level ECU 50 may be connected to the communication IF 22 of the first intermediate ECU 20 via a common communication bus. The communication IF 32 of the second intermediate ECU 30 is connected to the communication IF 62 of the third lower-level ECU 60 via the communication bus 64. The communication IFs 22 and 32 of the first and second intermediate ECUs 20 and 30 are configured to serve as gateways when the higher-level ECU 10 and the first to third lower-level ECUs 40, 50, and 60, which are connected to different communication buses 38, 44, 54, and 64, communicate with each other.

The in-vehicle network system 100 can use CAN (registered trademark) as the communication protocol for mutual communication among the respective communication IFs 12, 22, 32, 42, 52, and 62 of the higher-level ECU 10, the first and second intermediate ECUs 20 and 30, and the first to third lower-level ECUs 40, 50, and 60. CAN is an abbreviation for Controller Area Network. It should be noted that the communication protocol is not limited to CAN. The in-vehicle network system 100 can employ a variety of communication protocols such as Ethernet (registered trademark), LIN (Local Interconnect Network), FlexRay (registered trademark), and CAN-FD (CAN with Flexible Data Rate). For example, different communication protocols may be adopted for the different communication buses 38, 44, 54, and 64.

The higher-level ECU 10 may function as a domain controller that oversees the control of the first and second intermediate ECUs 20 and 30, as well as the first to third lower-level ECUs 40, 50, and 60. A domain refers to a functional unit when the vehicle's functions are broadly categorized, such as a powertrain domain, chassis domain, advanced driver assistance domain, body domain, and cockpit domain. The above are examples of domain classification, and the domains may be classified differently from the examples described above. Alternatively, the higher-level ECU 10 may function as an area controller that oversees the control of the first and second intermediate ECUs 20 and 30, and the first to third lower-level ECUs 40, 50, and 60, arranged in one area of the vehicle.

The higher-level ECU 10 includes a vehicle state management unit 14 that transmits vehicle state information relating to the state of the vehicle to the first and second intermediate ECUs 20 and 30 and the first to third lower-level ECUs 40, 50, and 60. The vehicle state management unit 14 transmits the vehicle state information based on the state of the vehicle as determined from information acquired from sensors and other ECUs (for example, states such as driving, stopped, or parked, and/or the status of various functions of the vehicle operated by the user). It should be noted that the vehicle state management unit 14 may be provided not in the higher-level ECU 10, but in another ECU such as the first or second intermediate ECU 20 or 30. Furthermore, the vehicle state management unit 14 may be distributed across multiple ECUs. In this case, the ECU that receives the vehicle state information may obtain necessary vehicle state information by integrating or selecting from among multiple pieces of vehicle state information acquired from the multiple ECUs.

The first and second intermediate ECUs 20 and 30 have, as one of their functions, a first relay control unit 24 and a second relay control unit 34, respectively. The first and second relay control units 24 and 34 determine which of the relay circuits 26, 28, and 36 to turn on and/or which of the relay circuits 26, 28, and 36 to keep off based on the acquired vehicle state information. The first and second relay control units 24 and 34 store in advance, in the form of a table or the like, the correspondence between various vehicle states and the relay circuits 26, 28, and 36 that supply power to the lower-level ECUs 40, 50, and 60 which need to operate in each respective vehicle state. By referring to the stored table, the first and second relay control units 24 and 34 can determine which relay circuits 26, 28, and 36 should be turned on and which should be turned off based on the acquired vehicle state information.

The first intermediate ECU 20 has the first and second relay circuits 26 and 28, and the second intermediate ECU 30 has the third relay circuit 36. The first relay control unit 24 of the first intermediate ECU 20 turns the first and second relay circuits 26 and 28 on or off according to the determination result based on the vehicle state information. The second relay control unit 34 of the second intermediate ECU 30 also turns the third relay circuit 36 on or off according to the determination result based on the vehicle state information.

The first relay circuit 26 is provided on the power supply line 6 for supplying electric power to the first lower-level ECU 40. In other words, the power line of the first lower-level ECU 40 is connected to a first power port 26a, which is connected to the first relay circuit 26. The second relay circuit 28 is provided on the power supply line 6 for supplying electric power to the second lower-level ECU 50. In other words, the power line of the second lower-level ECU 50 is connected to a second power port 28a, which is connected to the second relay circuit 28. The third relay circuit 36 is provided on the power supply line 6 for supplying electric power to the third lower-level ECU 60. In other words, the power line of the third lower-level ECU 40 is connected to a third power port 36a, which is connected to the third relay circuit 36.

The first to third relay circuits 26, 28, and 36 may be formed of semiconductor switches such as MOSFETs or IGBTs. However, the first to third relay circuits 26, 28, and 36 may be formed not by semiconductor switches, but by ordinary mechanical relays. Further, the first to third relay circuits 26, 28, and 36 may be provided inside the first and second intermediate ECUs 20 and 30 as shown in FIG. 1, or may be provided outside the first and second intermediate ECUs 20 and 30.

The first to third lower-level ECUs 40, 50, and 60 may be control ECUs for controlling predetermined control targets in a vehicle, or sensor ECUs that calculate predetermined physical quantities based on detection signals detected by sensors. The first to third lower-level ECUs 40, 50, and 60 enter a normal operation mode by being started through power supply when the corresponding relay circuits 26, 28, and 36 are turned on by the first and second intermediate ECUs 20 and 30. Then, in the normal operation mode, the first to third lower-level ECUs 40, 50, and 60 execute necessary control processing, such as control processing for controlling control targets, or control processing for calculating predetermined physical quantities based on detection signals from sensors. On the other hand, when it is not necessary to control the control target or calculate the predetermined physical quantity, and the corresponding relay circuits 26, 28, and 36 are turned off, the first to third lower-level ECUs 40, 50, and 60 enter a power cutoff state.

While operating in the normal operation mode, the first to third lower-level ECUs 40, 50, and 60 can acquire vehicle state information from the higher-level ECU 10. Then, the first to third lower-level ECUs 40, 50, and 60 can determine whether the vehicle has entered a state in which their respective control processing is unnecessary, based on the acquired vehicle state information. When the first to third lower-level ECUs 40, 50, and 60 determine that the vehicle has entered a state in which their respective control processing is unnecessary, they end their own control processing. Then, upon completion of their respective control processing, the first to third lower-level ECUs 40, 50, and 60 execute predetermined end processing. The predetermined end processing may include processes for saving backup data, such as backing up data generated during the course of control processing and backing up learning data in cases where the control processing involves learning.

Furthermore, while executing the aforementioned control processing and end processing, the first to third lower-level ECUs 40, 50, and 60 periodically transmit periodic messages to the first and second intermediate ECUs 20 and 30. More specifically, the first to third lower-level ECUs 40, 50, and 60 repeatedly transmit, at predetermined intervals (i.e., transmission intervals), periodic messages indicating that they are operating, via the communication buses 44, 54, and 64. Accordingly, the first and second intermediate ECUs 20 and 30 (i.e., the first and second relay control units 24 and 34) can determine whether the first to third lower-level ECUs 40, 50, and 60 are operating, based on the periodic messages regularly transmitted from the first to third lower-level ECUs 40, 50, and 60. It should be noted that, in the following description, the first and second intermediate ECUs 20 and 30 may be used synonymously with the first and second relay control units 24 and 34.

When the first and second intermediate ECUs 20 and 30 receive a periodic message from the same first to third lower-level ECUs 40, 50, and 60 without an elapse of the transmission interval of the periodic message after receiving a periodic message from the first to third lower-level ECUs 40, 50, and 6, the corresponding first to third lower-level ECUs 40, 50, and 60 can be regarded as operating, that is, as being in the process of executing control processing or end processing. On the other hand, when the first and second intermediate ECUs 20 and 30 do not receive a periodic message from the same first to third lower-level ECUs 40, 50, and 60 within the transmission interval of the periodic message after receiving a periodic message from the first to third lower-level ECUs 40, 50, and 60, the corresponding first to third lower-level ECUs 40, 50, and 60 can be regarded as having completed both control processing and end processing, and as having stopped operating.

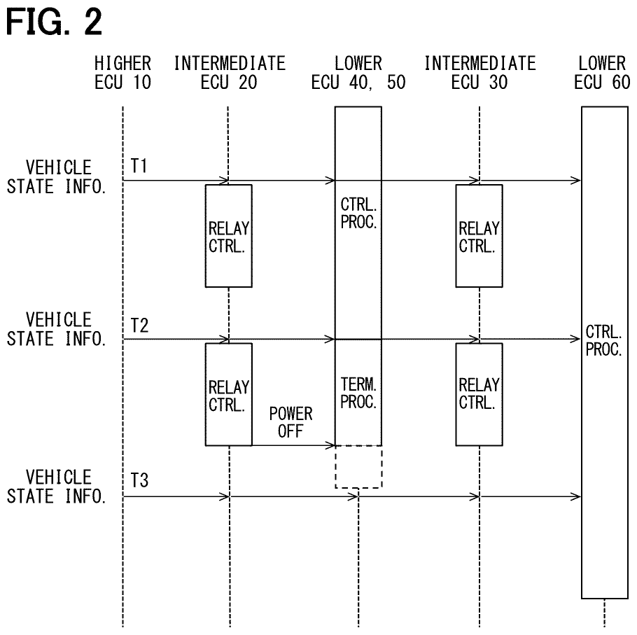

Here, when the first and second intermediate ECUs 20 and 30 control the ON and OFF states of the first to third relay circuits 26, 28, and 36 based solely on vehicle state information, without taking into account the conditions of the first to third lower-level ECUs 40, 50, and 60, various problems may occur. An example of such a problem will be described with reference to FIG. 2.

As shown in the sequence diagram of FIG. 2, when the first intermediate ECU 20 receives vehicle state information at times T1 and T2, the first intermediate ECU 20 executes relay control processing. The relay control processing includes determining whether the vehicle state information includes information based on which the first and second relay circuits 26 and 28 are to be turned off. Furthermore, the relay control processing includes outputting drive signals to turn off the first and second relay circuits 26 and 28 when it is determined that the vehicle state information includes information based on which the first and second relay circuits 26 and 28 are to be turned off. When it is determined that the vehicle state information does not include information based on which the first and second relay circuits 26 and 28 are to be turned off, the first and second relay circuits 26 and 28 are maintained in the ON state.

The sequence diagram in FIG. 2 shows an example in which, at time T2, the vehicle state information received by the first intermediate ECU 20 from the higher-level ECU 10 includes information based on which the first and second relay circuits 26 and 28 are to be turned off. The first intermediate ECU 20 starts relay control in response to receiving the vehicle state information at time T2. In addition, the first and second lower-level ECUs 40 and 50 also receive the vehicle state information from the higher-level ECU 10 at time T2. Then, the first and second lower-level ECUs 40 and 50 determine, based on the received vehicle state information, that the current vehicle state does not require their own control processing. Thus, the first and second lower-level ECUs 40 and 50 end their control processing and start predetermined end processing.

However, when the first intermediate ECU 20 turns off the first and second relay circuits 26 and 28 through relay control processing, the first and second lower-level ECUs 40 and 50 may still be executing their end processing, as shown in FIG. 2. If the power supply is cut off while the first and second lower-level ECUs 40 and 50 are executing their end processing, necessary backup data may not be saved.

Thus, in the in-vehicle network system 100 according to the present embodiment, the first and second intermediate ECUs 20 and 30 determine whether to turn the first to third relay circuits 26, 28, and 36 on or off not only based on the vehicle state information, but also based on periodic messages which are regularly transmitted from the first to third lower-level ECUs 40, 50, and 60, and indicate that the first to third lower-level ECUs 40, 50, and 60 are operating.

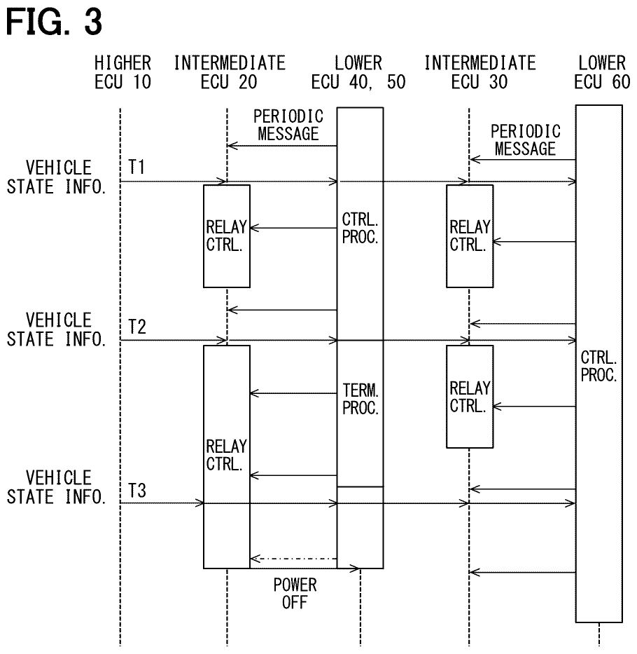

More specifically, as illustrated in the sequence diagram of FIG. 3, the first intermediate ECU 20 continues to keep the first and second relay circuits 26 and 28 on as long as periodic messages are being transmitted from the first and second lower-level ECUs 40 and 50, even when the first intermediate ECU 20 receives vehicle state information at time T2 that includes information based on which the first and second relay circuits 26 and 28 are turned off, and initiates relay control. The first intermediate ECU 20 monitors the periodic messages from the first and second lower-level ECUs 40 and 50. Then, when the first intermediate ECU 20 does not receive a periodic message from the first and second lower-level ECUs 40 and 50 after a period longer than the transmission interval for the periodic messages has passed since the last receipt of the message, the first intermediate ECU 20 determines that the relevant lower-level ECU 40 or 50 has completed its control processing and end processing. As illustrated in FIG. 3, when the first intermediate ECU 20 acquires vehicle state information including information based on which the first and second relay circuits 26 and 28 are turned off, and determines that the first and second lower-level ECUs 40 and 50 have completed their control processing and end processing, the first intermediate ECU 20 turns off the first and second relay circuits 26 and 28 to cut off the power supply.

Accordingly, in the in-vehicle network system 100 according to the present embodiment, it is possible to prevent the supply of power to the first to third lower-level ECUs 40, 50, and 60 from being cut off while the first to third lower-level ECUs 40, 50, and 60 are performing control processing or end processing. In other words, it is possible to cut off the power supply to the first to third lower-level ECUs 40, 50, and 60 at an appropriate timing after the completion of the control processing and end processing.

It should be noted that, in the example shown in FIG. 3, after the end processing has been completed by the first and second intermediate ECUs 20 and 30, the first and second lower-level ECUs 40 and 50 enter a standby state in which power is still supplied but processing has been stopped. In this standby state, periodic messages are not transmitted as indicated by the dashed line in FIG. 3. Thus, based on the absence of periodic messages indicated by the dashed line, the first intermediate ECU 20 can recognize that the first and second lower-level ECUs 40 and 50 have completed control processing and end processing.

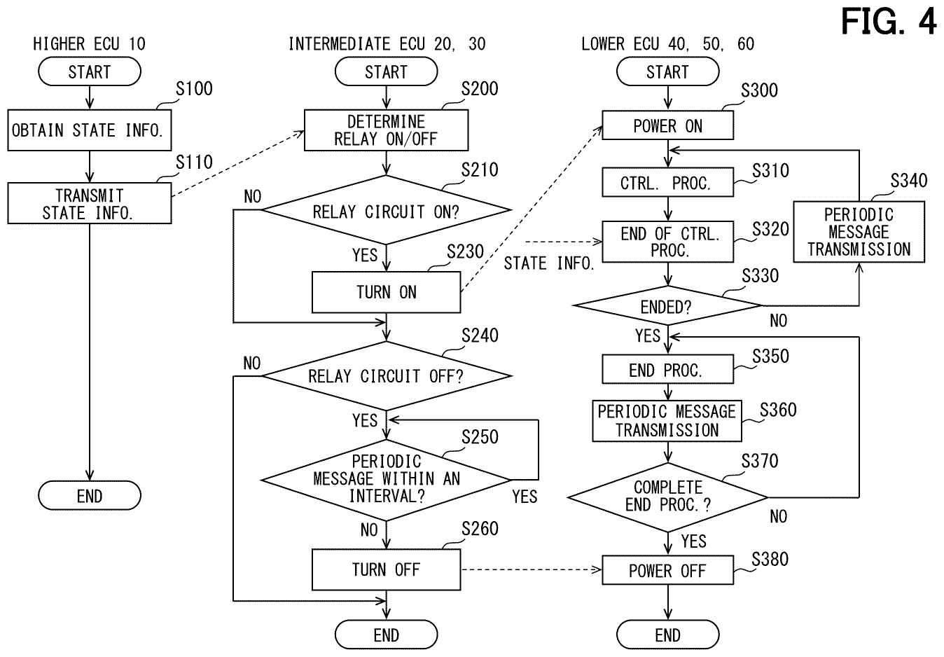

Next, with reference to the flowchart in FIG. 4, an example of the processing executed in the higher-level ECU 10, the first and second intermediate ECUs 20 and 30, and the first to third lower-level ECUs 40, 50, and 60, for turning the first to third relay circuits 26, 28, and 36 on or off, will be described. The higher-level ECU 10, as well as the first and second intermediate ECUs 20 and 30, repeatedly execute the processing shown in the flowchart of FIG. 4 at predetermined intervals. In addition, the first and second intermediate ECUs 20 and 30, as well as the first to third lower-level ECUs 40, 50, and 60, individually execute the processing shown in the flowchart of FIG. 4. It should be noted that the higher-level ECU 10, the first and second intermediate ECUs 20 and 30, and the first to third lower-level ECUs 40, 50, and 60 each executing the processing shown in the flowchart of FIG. 4 corresponds to executing the control method for the in-vehicle network system according to the present disclosure.

The higher-level ECU 10 (the vehicle state management unit 14), in step S100, acquires information regarding the state of the vehicle (for example, states such as driving, stopped, or parked, and/or the status of various functions of the vehicle operated by the user) from sensors and other ECUs. In step S110, the higher-level ECU 10 transmits the information regarding the state of the vehicle acquired in step S100, as vehicle state information, to the first and second intermediate ECUs 20 and 30, as well as to the first to third lower-level ECUs 40, 50, and 60.

The first and second intermediate ECUs 20 and 30, in step S200, receive the vehicle state information from the higher-level ECU 10 and determine whether the first to third relay circuits 26, 28, and 36 are turned on or off, based on the received vehicle state information. In step S210, the first and second intermediate ECUs 20 and 30 determine whether at least one of the relay circuits 26, 28, or 36 has been determined to be turned on in the determination process of step S200. When it is determined that at least one of the relay circuits 26, 28, or 36 has been determined to be turned on, the first and second intermediate ECUs 20 and 30 proceed the processing to step S230. On the other hand, when it is determined that none of the relay circuits 26, 28, or 36 have been determined to be turned on, the first and second intermediate ECUs 20 and 30 proceed the processing to step S240.

In step S230, the first and second intermediate ECUs 20 and 30 output drive signals to turn on the corresponding relay circuits 26, 28, or 36 that have been determined to be turned on. As a result, power is supplied to the first, second and/or third lower-level ECUs 40, 50, 60 connected to the relay circuits 26, 28, 36 that have been turned ON.

In step S240, the first and second intermediate ECUs 20 and 30 determine whether at least one of the relay circuits 26, 28, or 36 has been determined to be turned off in the determination processing of step S200. When it is determined that at least one of the relay circuits 26, 28, or 36 has been determined to be turned off, the first and second intermediate ECUs 20 and 30 proceed the processing to step S250. On the other hand, when it is determined that none of the relay circuits 26, 28, or 36 has been determined to be turned off, the first and second intermediate ECUs 20 and 30 end the processing shown in the flowchart of FIG. 4.

In step S250, the first and second intermediate ECUs 20 and 30 determine whether a new periodic message has been received from the first to third lower-level ECUs 40, 50, and 60 before the transmission interval of the periodic message has elapsed since the periodic message was received. When it is determined that a new periodic message has been received, the corresponding first to third lower-level ECUs 40, 50, or 60 are executing control processing or end processing. Thus, the first and second intermediate ECUs 20 and 30 repeatedly execute the processing of step S250 until they no longer receive new periodic messages from the first to third lower-level ECUs 40, 50, and 60, in other words, until the first to third lower-level ECUs 40, 50, and 60 stop operating. On the other hand, when, in step S250, the first and second intermediate ECUs 20 and 30 determine that no new periodic message has been received before the transmission interval of the periodic message has elapsed, the process proceeds to step S260.

In step S260, the first and second intermediate ECUs 20 and 30 turn off the corresponding first to third relay circuits 26, 28, and 36 associated with the first to third lower-level ECUs 40, 50, and 60 from which no periodic message has been received. As a result, the power supply to the first to third lower-level ECUs 40, 50, and 60 connected to the relay circuits 26, 28, and 36 that have been turned off is cut off.

In step S300, the first to third lower-level ECUs 40, 50, and 60 to which power is supplied start up and enter the normal operation mode. In step S310, the first to third lower-level ECUs 40, 50, and 60, which have entered the normal operation mode, execute necessary control processes, such as control processing for controlling the controlled object and control processing for calculating a predetermined physical quantity based on sensor detection signals.

In step S320, the first to third lower-level ECUs 40, 50, and 60 operating in the normal operation mode receive vehicle state information from the higher-level ECU 10, and based on the received vehicle state information, determine whether their own control processing is unnecessary for the current vehicle state. That is, the first to third lower-level ECUs 40, 50, and 60 determine whether their own control processing should be ended based on the vehicle state information. In step S330, the first to third lower-level ECUs 40, 50, and 60 determine whether the determination result in step S320 indicates end of the control processing. When the determination result does not indicate end of the control processing, the first to third lower-level ECUs 40, 50, and 60 proceed the processing to step S340. On the other hand, when the determination result indicates end of the control processing, the first to third lower-level ECUs 40, 50, and 60 proceed the processing to step S350.

In step S340, the first to third lower-level ECUs 40, 50, and 60 execute processing to transmit periodic messages at predetermined transmission intervals. Then, the first to third lower-level ECUs 40, 50, and 60 return to the processing of step S310.

In step S350, the first to third lower-level ECUs 40, 50, and 60 execute a predetermined end processing. The predetermined end processing may include processing of saving backup data, such as backing up data generated during the course of control processing and backing up learning data in cases where the control processing involves learning. In step S360, the first to third lower-level ECUs 40, 50, and 60 execute processing to transmit periodic messages at predetermined transmission intervals. In this way, the first to third lower-level ECUs 40, 50, and 60 transmit periodic messages even while executing the predetermined end processing.

In step S370, the first to third lower-level ECUs 40, 50, and 60 determine whether the predetermined end processing has been completed. When it is determined that the predetermined end processing has not been completed, the first to third lower-level ECUs 40, 50, and 60 return to the processing of step S350. On the other hand, when it is determined that the predetermined termination processing has been completed, the first to third lower-level ECUs 40, 50, and 60 proceed the processing to step S380. At this point, since the first to third lower-level ECUs 40, 50, and 60 have completed the predetermined end processing, they enter a standby state in which power is being supplied but processing is stopped. In step S380, the first to third lower-level ECUs 40, 50, and 60 transition from the standby state to the power-off state by the intermediate ECUs 20 and 30 turning off the corresponding relay circuits 26, 28, and 36.

As described above, in the in-vehicle network system 100 according to the present embodiment, the first and second intermediate ECUs 20 and 30 continue to keep the first to third relay circuits 26, 28, and 36 turned on as long as periodic messages are being transmitted from the first to third lower-level ECUs 40, 50, and 60, even if the vehicle state information changes to have information based on which at least one of the first to third relay circuits 26, 28, and 36 is turned off. Accordingly, in the in-vehicle network system 100 according to the present embodiment, it is possible to prevent the supply of power to the first to third lower-level ECUs 40, 50, and 60 from being cut off while the first to third lower-level ECUs 40, 50, and 60 are performing control processing or end processing. Accordingly, the first and second intermediate ECUs 20 and 30 can cut off the power supply to the first to third lower-level ECUs 40, 50, and 60 at an appropriate timing after the control processing and end processing in the first to third lower-level ECUs 40, 50, and 60 have been completed.

(Second Embodiment) Next, an in-vehicle network system and the control method for the in-vehicle network system of the second embodiment according to the present disclosure will be described. The in-vehicle network system 100A according to the present embodiment is configured in largely the same manner as the in-vehicle network system 100 of the first embodiment. Accordingly, components that are the same as those in the in-vehicle network system 100 of the first embodiment will be denoted by the same reference numerals and detailed description thereof will be omitted.

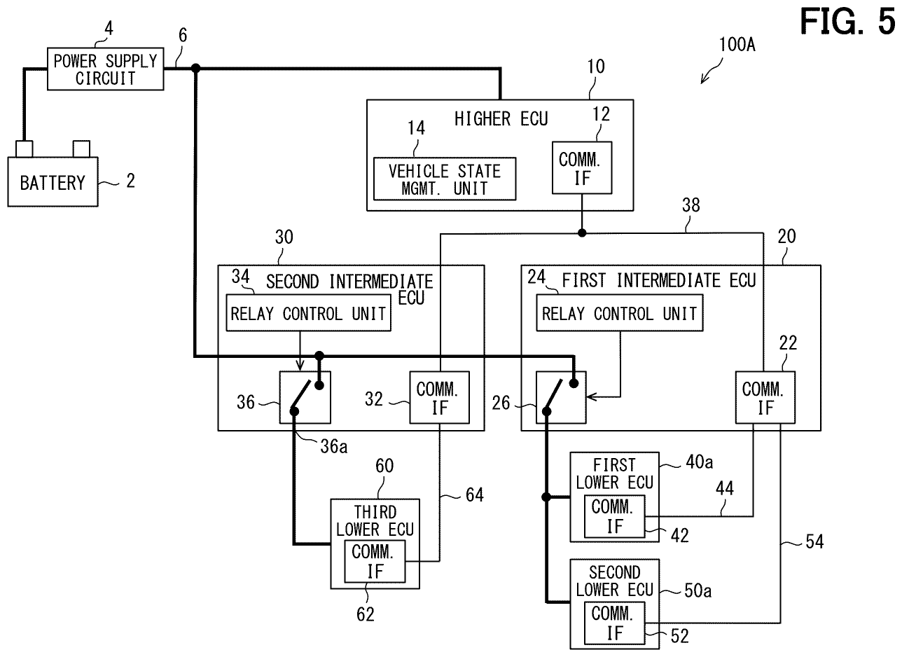

FIG. 5 is a configuration diagram showing an example of the configuration of the in-vehicle network system 100A according to the second embodiment. As shown in FIG. 5, in the in-vehicle network system 100A according to the present embodiment, a first lower-level ECU 40a and a second lower-level ECU 50a are connected to the first relay circuit 26, which is controlled to turn on and off by the first intermediate ECU 20. The number of lower-level ECUs connected to the first relay circuit 26 is not limited to two, and three or more lower-level ECUs may also be connected to the first relay circuit 26.

When multiple lower-level ECUs (the first and second lower-level ECUs 40a and 50a) are connected to the single first relay circuit 26, the first relay control unit 24 of the first intermediate ECU 20 needs to turn off the first relay circuit 26 in consideration of the processing status of the multiple lower-level ECUs (the first and second lower-level ECUs 40a and 50a).

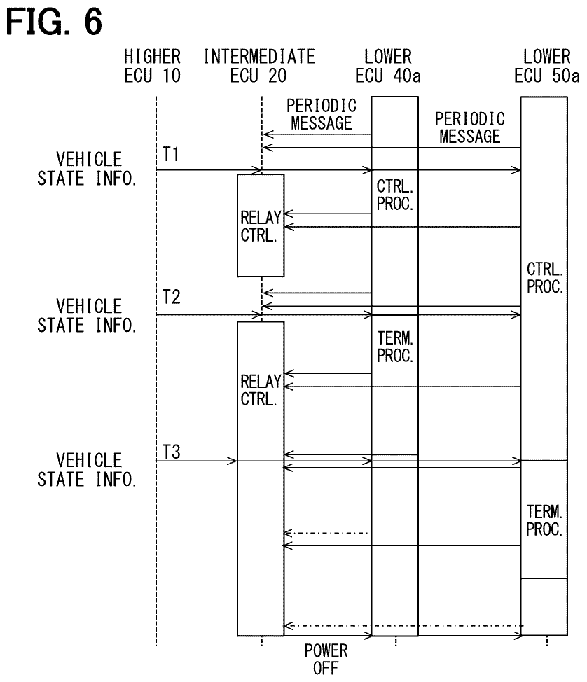

In this regard, in the in-vehicle network system 100A according to the present embodiment, as shown in the sequence diagram of FIG. 6, the first intermediate ECU 20 (the first relay control unit 24) is configured not to turn off the first relay circuit 26 merely when the periodic message from any one of the lower-level ECUs (the first lower-level ECU 40a or the second lower-level ECU 50a) is interrupted. Instead, the first relay circuit 26 is turned off in response to the interruption of periodic messages from all of the lower-level ECUs (the first lower-level ECU 40a and the second lower-level ECU 50a).

For example, in the sequence diagram shown in FIG. 6, at time T2, vehicle state information indicating a vehicle state in which control processing by the first lower-level ECU 40a is unnecessary but control processing by the second lower-level ECU 50a is necessary is transmitted from the higher-level ECU 10. In response to receiving this vehicle state information, the first lower-level ECU 40a ends its control processing and starts predetermined end processing. On the other hand, since the vehicle state information indicates that control processing by the second lower-level ECU 50a is necessary, the second lower-level ECU 50a continues its control processing. It should be noted that the vehicle state information transmitted from the higher-level ECU 10 at time T2 is also received by the first intermediate ECU 20. The first intermediate ECU 20 determines to turn off the relay circuit 26 corresponding to the first lower-level ECU 40a and to turn on the relay circuit corresponding to the second lower-level ECU 50a based on the received vehicle state information.

At time T3, vehicle state information indicating a vehicle state in which control processing by the second lower-level ECU 50a is no longer necessary is transmitted from the higher-level ECU 10. In response to receiving the vehicle state information, the second lower-level ECU 50a ends its control processing and starts predetermined end processing. In this way, the timing at which the first lower-level ECU 40a and the second lower-level ECU 50a end their respective control processing may differ. In addition, the vehicle state information transmitted from the higher-level ECU 10 at time T3 is also received by the first intermediate ECU 20. The first intermediate ECU 20 determines, based on the received vehicle state information, to turn off the relay circuit 26 corresponding to the second lower-level ECU 50a.

For example, if the timing at which the first and second lower-level ECUs 40a and 50a end their respective control processing differs, there is a case where the first lower-level ECU 40a completes its predetermined end processing and stops transmitting periodic messages as indicated by the dashed arrow in FIG. 6, but the second lower-level ECU 50a is still executing its predetermined end processing and transmit periodic messages. In this case, since the second lower-level ECU 50a is still operating, the first intermediate ECU 20 maintains the on state of the first relay circuit 26.

Then, as indicated by the dashed arrow in FIG. 6, when the first intermediate ECU 20 determines that the transmission of periodic messages from the second lower-level ECU 50a has stopped, the first intermediate ECU 20 turns off the first relay circuit 26 and cuts off the power supply to the first and second lower-level ECUs 40a and 50a.

As described above, according to the in-vehicle network system 100A of the present embodiment, the first intermediate ECU 20 keeps the first relay circuit 26 on as long as periodic messages are being transmitted from at least one of the first and second lower-level ECUs 40a and 50a, even when the vehicle state information changes to have information based on which the first relay circuit 26 is turned off. As a result, according to the in-vehicle network system 100A of the present embodiment, it is possible to avoid turning off the relay circuit 26 while at least one of the lower-level ECUs 40a and 50a connected to the single relay circuit 26 is performing control processing or end processing.

In the example described above, the lower-level ECUs 40a and 50a had different timings for completing their respective control processes, resulting in differences in the timing of completion of their respective end processes. However, the factors causing differences in the timing of completion of the respective end processes are not limited to differences in the timing of completion of the control processes. For example, the time required to execute the respective end processes by the lower-level ECUs 40a and 50a may differ. In this case as well, the timings for completion of the termination processes of the lower-level ECUs 40a and 50a will differ.

(Third Embodiment) Next, a third embodiment of the in-vehicle network system and the control method for the in-vehicle network system according to the present disclosure will be described. The in-vehicle network system 100B according to the present embodiment is configured in substantially the same manner as the in-vehicle network system 100 according to the first embodiment. Accordingly, components that are the same as those in the in-vehicle network system 100 of the first embodiment will be denoted by the same reference numerals and detailed description thereof will be omitted.

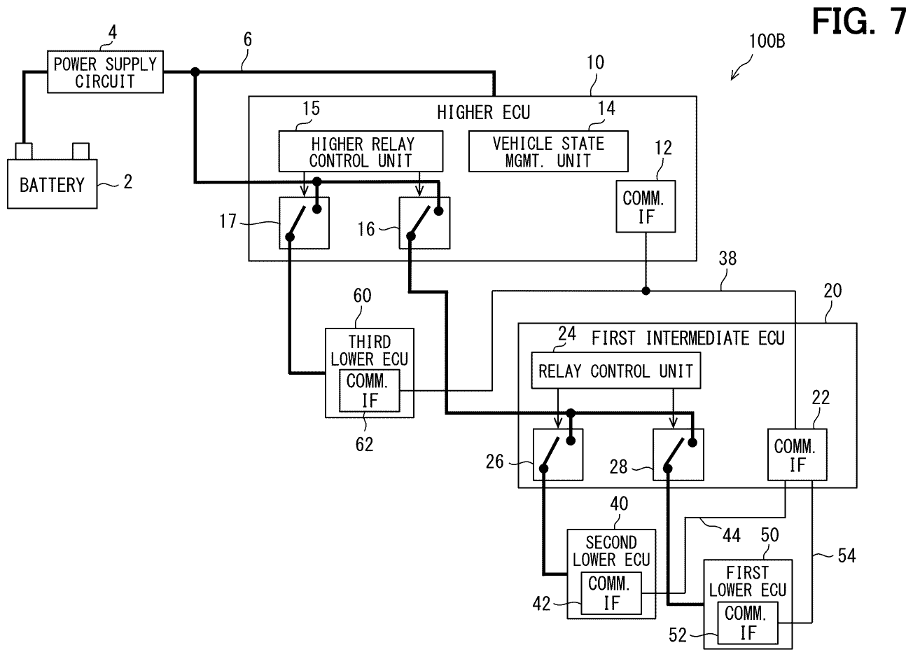

FIG. 7 is a configuration diagram showing an example of the configuration of the in-vehicle network system 100B according to the third embodiment. As shown in FIG. 7, in the in-vehicle network system 100B according to the present embodiment, a higher-level relay control unit 15 is provided in the higher-level ECU 10. The first intermediate ECU 20 is configured to receive power supply via a fourth relay circuit 16, which is controlled to turn on and off by the higher-level relay control unit 15. As a result, the first and second lower-level ECUs 40 and 50 are supplied with power not only via the first and second relay circuits 26 and 28, but also via the fourth relay circuit 16.

The first intermediate ECU 20 periodically transmits periodic messages to the higher-level ECU 10 as long as the first intermediate ECU 20 maintains power supply to the first lower-level ECU 40 and/or the second lower-level ECU 50 by turning on the first relay circuit 26 and/or the second relay circuit 28. The first intermediate ECU 20 may also serve as a gateway to forward periodic messages from the first and second lower-level ECUs 40 and 50 to the higher-level ECU 10. If the first and second lower-level ECUs 40 and 50 are capable of communicating directly with the higher-level ECU 10 without passing through the first intermediate ECU 20, the first intermediate ECU 20 does not need to gateway the periodic messages from the first and second lower-level ECUs 40 and 50.

The higher-level ECU 10 (the higher-level relay control unit 15) continues to keep the fourth relay circuit 16, which corresponds to the higher-level relay circuit, turned on as long as periodic messages are being transmitted from the first intermediate ECU 20, even if the vehicle state information changes to have information based on which the fourth relay circuit 16 is turned off. At this time, the higher-level ECU 10 may also continue to keep the fourth relay circuit 16 turned on in accordance with receiving not only the periodic messages from the first intermediate ECU 20 but also the periodic messages from the first and second lower-level ECUs 40 and 50. In this way, the higher-level ECU 10 may be configured to monitor not only the periodic messages from the first intermediate ECU 20 but also the periodic messages from the first and second lower-level ECUs 40 and 50. As a result, the higher-level ECU 10 can avoid turning off the fourth relay circuit 16 while the first and second lower-level ECUs 40 and 50 are performing control processing or end processing.

In the third embodiment, the in-vehicle network system 100B includes three layers of the higher-level ECU 10, the first intermediate ECU 20, and the first and second lower-level ECUs 40 and 50. The relay circuits 16, 26, and 28 are provided in the higher-level ECU 10 and the first intermediate ECU 20, respectively. However, the hierarchy of the in-vehicle network system is not limited to three layers, and may have four or more layers. When the in-vehicle network system 100B is configured with four or more layers, a relay circuit for turning on or off the power supply to lower-level ECUs may be provided in the ECUs of each layer except the lowest layer.

In addition, in the in-vehicle network system 100B according to the third embodiment, the second intermediate ECU 30 is omitted. The third lower-level ECU 60 is configured to be supplied with power via a fifth relay circuit 17, the on/off state of which is controlled by the higher-level relay control unit 15 of the higher-level ECU 10. In this manner, the higher-level ECU 10 may be configured to directly control whether power is supplied to the lower-level ECU 60.

(Modification Example) As described above, preferred embodiments of the present disclosure have been explained. However, the present disclosure is not limited to the embodiments described above, and various modifications may be made without departing from the spirit of the disclosure.

(Modification Example 1) For example, in the first to third embodiments described above, the periodic messages transmitted by the first to third lower-level ECUs 40, 50, and 60 may be network management (hereinafter, NM) messages. An NM message is a message used to realize so-called partial networking, and includes, for example, an identifier indicating the source ECU and activation cluster information indicating the group of ECUs to be operated.

When partial networking is realized using NM messages, each ECU belonging to the in-vehicle network systems 100, 100A, and 100B is assigned to a cluster to which it belongs among divided clusters. The assigned cluster is held by each ECU as cluster configuration information. When an NM message is transmitted from a certain ECU and the NM message includes activation cluster information to request activation a certain cluster, the ECUs belonging to the certain cluster are activated and enter the normal operation mode, while the other ECUs remain in the sleep state.

As described above, since the NM message can include an identifier indicating the source ECU, it can be used as the periodic message in the present disclosure.

(Modification Example 2) The system and method described in the present disclosure may be implemented by a dedicated computer comprising a processor programmed to execute one or more functions embodied by a computer program. The system and method described in the present disclosure may also be implemented using dedicated hardware logic circuits. The system and method described in the present disclosure may also be implemented by one or more dedicated computers comprising a combination of a processor that executes a computer program and one or more hardware logic circuits. For example, some or all of the functions provided by the higher-level ECU 10, the first and second intermediate ECUs 20 and 30, and the first to third lower-level ECUs 40, 50, and 60 may be implemented as hardware. Modes of implementing a certain function as hardware include implementations using one or more ICs or the like. Some or all of the functions provided by the higher-level ECU 10, the first and second intermediate ECUs 20 and 30, and the first to third lower-level ECUs 40, 50, and 60 may be implemented using any of a system-on-chip (SoC), an integrated circuit (IC), or a field-programmable gate array (FPGA). The concept of IC also includes an ASIC (Application Specific Integrated Circuit). Further, the computer program may be stored, as instructions to be executed by a computer, on a computer-readable non-transitory tangible storage medium. As storage media for the program, devices such as HDDs (Hard Disk Drives), SSDs (Solid State Drives), or flash memory can be used. Further, a program for causing a computer to function as the higher-level ECU 10, the first and second intermediate ECUs 20 and 30, and the first to third lower-level ECUs 40, 50, and 60, as well as non-transitory tangible storage media such as semiconductor memory on which such a program is recorded, are also included within the scope of the present disclosure.

In the present disclosure or the claims, the phrase “at least one of a circuit and a processor” should be interpreted disjunctively (logical OR) and should not be interpreted as at least one circuit and at least one processor.

1. An in-vehicle network system comprising:
a first controller;
a second controller that is positioned hierarchically higher than the first controller, wherein the second controller includes at least one of (i) a first circuit and (ii) a first processor with a memory storing computer program code executable by the first processor, the at least one of the first circuit and the first processor configured to cause the second controller to turn on or off a relay circuit that is disposed on a power supply line to the first controller; and
a third controller including at least one of (i) a second circuit and (ii) a second processor with a memory storing computer program code executable by the second processor, wherein
the third controller includes a power supply control master and a NM control master,
the power supply control master is configured to transmit a relay control message to the second controller based on a vehicle state of a vehicle, the relay control message containing an instruction to turn on or off the relay circuit,
the NM control master is configured to transmit an activation network management (NM) message to the second controller through a communication bus in the vehicle in response to an activation trigger that requires the second controller to operate in a normal operation mode, the activation NM message causing the second controller in a low-power consumption mode to enter the normal operation mode and containing an instruction to selectively activate the first controller, and
the second controller is configured to turn on or off the relay circuit based on the instruction contained in the activation NM message until the second controller receives the relay control message from the power supply control master.

2. The in-vehicle network system according to claim 1, wherein
the power supply control master is configured to transmit the relay control message after the second controller has entered the normal operation mode in response to the activation NM message.

3. The in-vehicle network system according to claim 1, wherein
the second controller is configured to turn on or off the relay circuit based on the instruction contained in the relay control message instead of the instruction contained in the activation NM message when the second controller has received the relay control message from the power supply control master.

4. The in-vehicle network system according to claim 1, wherein
the second controller is configured to:
turn on or off the relay circuit based on the instruction contained in the activation NM message; and then
turn on or off the relay circuit based on the instruction contained in the relay control message when the second controller has received the relay control message.

5. The in-vehicle network system according to claim 1, wherein
the NM control master is configured to repeatedly transmit the activation NM message at predetermined intervals until the second controller receives the relay control message from the power supply control master.

6. The in-vehicle network system according to claim 5, wherein
the second controller is configured to:
activate in response to the activation NM message and enter the normal operation mode;
read an activation NM message that is received after activation of the second controller; and
turn on or off the relay circuit based on the instruction contained in the activation NM message received after the activation.

7. The in-vehicle network system according to claim 1, wherein
the second controller is configured to:
activate in response to the activation NM message and enter the normal operation mode; and then
turn on the relay circuit before reading the activation NM message or an activation NM message that is received after activation of the second controller.

8. The in-vehicle network system according to claim 7, wherein
the second controller is configured to turn off the relay circuit when the activation NM message having been read by the second controller contains an instruction to turn off the relay circuit.

9. The in-vehicle network system according to claim 1, wherein
the activation NM message and/or the relay control message includes a message authenticator to authenticate validity of the activation NM message and/or the relay control message.

10. The in-vehicle network system according to claim 1, wherein
the NM control master is one of multiple NM control masters, and
the second controller is configured to turn on the relay circuit when at least one of activation messages transmitted by the multiple NM control masters contains an instruction to turn on the relay circuit.

11. The in-vehicle network system according to claim 1, wherein
the second controller is configured to keep the relay circuit turned on for a predetermined period when the second controller turns on the relay circuit based on the activation NM message.

12. The in-vehicle network system according to claim 1, wherein
the third controller is positioned hierarchically higher than the second controller.

13. The in-vehicle network system according to claim 12, wherein
the second controller is one of second controllers, and
the power supply control master is configured to individually instruct the second controllers to turn on or off the relay circuit based on the vehicle state, using the relay control message.

14. A control method of an in-vehicle network system including a first controller and a second controller positioned hierarchically higher than the first controller, the control method comprising:
transmitting, to the second controller, a relay control message containing an instruction to turn on or off a relay circuit based on a vehicle state of a vehicle, the relay circuit being disposed on a power supply line to the first controller;
transmitting, to the second controller, an activation network management (NM) message through a communication bus in response to an activation trigger that requires the second controller to transition to a normal operation mode, the activation NM message causing the second controller to transition from a low-power consumption mode to the normal operation mode and containing an instruction to selectively activate the first controller; and
turning on or off, with a relay control unit of the second controller, the relay circuit based on the instruction contained in the activation NM message until the second controller receives the relay control message.

15. An in-vehicle network system comprising:
a first controller;
a second controller that is positioned hierarchically higher than the first controller, wherein the first controller and the second controller are connected to a communication bus to communicate with each other in a vehicle, and the second controller includes a relay control unit configured to turn on or off a relay circuit (26, 28, 36) that is disposed on a power supply line to the first controller;
a power supply control master configured to transmit a relay control message to the second controller based on a vehicle state of the vehicle, the relay control message containing an instruction to turn on or off the relay circuit; and
a NM control master configured to transmit an activation network management (NM) message to the second controller through the communication bus in response to an activation trigger that requires the second controller to transition to a normal operation mode, the activation NM message causing the second controller to transition from a low-power consumption mode to the normal operation mode and containing an instruction to selectively activate the first controller, wherein
the second controller is configured to turn on or off the relay circuit based on the instruction contained in the activation NM message until the second controller receives the relay control message from the power supply control master.

16. The in-vehicle network system according to claim 15, further comprising
a third controller that is positioned hierarchically higher than the second controller, wherein
the third controller includes the power supply control master.
